(19) United States
(12) Patent Application Publication
(10) Pub. No.: US 2014/0166790 A1
(43) Pub. Date: Jun. 19, 2014

(54) Method and Apparatus for Maintaining a Feed Roller Parallel to an Infeed Floor Through its Range of Motion

(71) Applicant: VERMEER MANUFACTURING COMPANY, Pella, IA (US)

(72) Inventors: Gary Verhoef, Pella, IA (US); Brian Johnson, Monroe, IA (US)

(73) Assignee: VERMEER MANUFACTURING COMPANY, Pella, IA (US)

(21) Appl. No.: 13/713,138

(22) Filed: Dec. 13, 2012

(51) Int. Cl. B02C 23/02; B02C 23/00

(52) U.S. Cl. CPC B02C 23/02; B02C 23/00
USPC 241/30; 241/34

(57) ABSTRACT

An infeed system for a horizontal grinder intended to process loose, unconsolidated materials includes a feed table with a chain conveyor on a floor and sides to support the material to be processed. The infeed system further includes an upper feed roller configured for powered rotation so that the outer surface moves in coordination with the chain conveyor to move material to a grinding chamber. The feed roller is positioned between the sides to minimize the potential for materials to become wedged or trapped. A hydraulic circuit and control system to control the position/orientation of the feed roller to keep it parallel to the feed table.

### BACKGROUND OF THE INVENTION

Many prior art horizontal grinders have traditionally had a feed system including a feed roller and a feed table. The feed roller has typically been mounted on a pivoting frame to ride up onto material being fed into a grinding chamber while the feed table moved the material from below. The feed table of a horizontal grinder is typically in excess of 6 feet wide to allow convenient handling of the materials typically processed by a horizontal grinder.

The feed roller is typically constructed to fit into the infeed of the grinder, to fit relatively closely to vertical side walls of the infeed, to minimize the probability of material getting lodged between the feed roller and the side wall. The roller is often subjected to uneven load conditions due to the variations in the position of the materials entering the grinder. There is seldom an equal distribution of material below the feed roller. This uneven load creates the tendency to tilt the feed roller. If allowed to tilt, the feed roller would become wedged between the infeed side walls. This potential problem has traditionally been averted by designing the pivoting frame to have sufficient rigidity to control the alignment of the feed roller.

Prior art feed roller mounting systems have traditionally included the pivoting frame, and also a hydraulic system with a control valve and a pair of hydraulic cylinders, called lift cylinders, to control the position of the feed roller to lift the feed roller to allow material to more easily pass under, or to lower the feed roller into contact with the material to allow the feed roller to engage and assist with the material feeding.

When the hydraulic system lowers the feed roller into contact with the material, a down-force is applied onto the material. This down-force is a combination of the weight of the feed roller and its positioning mechanism and the down force generated by the hydraulic cylinders. The hydraulic systems have traditionally been designed using identical cylinders, one on the left side, and one on the right side of the grinder, both attached to the feed roller linkage. The hydraulic system was designed with the two butt-end ports of the cylinders merged, and the two rod-end ports merged to form a parallel arrangement. The control valve directed the hydraulic fluid to both cylinders which resulted in approximately equal pressures applied to each cylinder. Since the cylinders are identical, an approximately equal force was applied on each side of the feed roller lift linkage.

In the operating mode where the feed roller is lowered into contact with the material, the amount of pressure applied to the cylinders can be controlled by the operator. In such a system, when the pressure is low, the force generated by the cylinders may have negligible effect, wherein the weight of the feed roller and feed roller mechanism may provide most of the down-force on the material. In this mode when the feed roller encounters material that is not evenly distributed, such as an uneven pile of material, or when a log is located off to one side, the pivoting frame is subjected to bending due to the fact that the center of gravity of the roller and frame mechanism is offset from the reaction point, the point where the material being ground contacts the bottom of the roller. This is a common occurrence, and as a result the frame of a traditional grinder is designed to be rigid enough to keep the feed roller approximately parallel to the table.

To accomplish this rigid construction the frame mechanism for the feed roller has typically included a component capable of carrying the torque generated by the offset load. Typically the frame would flex to some degree, as required for the torque-carrying component to be loaded, to accommodate this offset load. The mechanism was typically designed to minimize the amount of flex to attempt to keep the feed roller generally parallel to the feed table. When the pressure is low the lift cylinders do not add significantly to this flexing, but they do not reduce the bending load applied to the frame as a result of material offset. Thus the pivoting frame carrying the feed roller has traditionally been designed to resist this bending load.

In a different operating mode, the lift cylinders exert down pressure on the material in order to increase the down-force to cause the feed roller to more aggressively force the material into the grinder hammer mill. With the down-force increased, the potential bending forces on the feed roller frame are increased. With the typical known hydraulic system, where the two cylinders are each supplied with a source of hydraulic fluid, the load generated by the cylinders adds to the bending stresses applied to the roller frame. This has resulted in the typical feed roller mounting structure being relatively significant, large, heavy and expensive.

Accordingly there is a need for a method and apparatus to ensure that the axis of a feed roller remains essentially parallel to the infeed floor throughout its range of motion, even when influenced by uneven or offset loading of material on the floor, but without the need to use a large, heavy, and expensive feed roller mounting structure.

### BRIEF SUMMARY OF THE INVENTION

The present invention is an infeed system for a horizontal grinder intended to process loose, unconsolidated materials. The infeed includes a feed table with a chain conveyor on a floor and sides to support the material to be processed. The infeed system further includes an upper feed roller configured for powered rotation so that the outer surface moves in coordination with the chain conveyor to move material to a grinding chamber. The feed roller is positioned between the sides to minimize the potential for materials to become wedged or trapped. A major advantage of this infeed system is the incorporation of a hydraulic circuit and control system to control the position or orientation of the feed roller to keep it parallel to the feed table. The preferred embodiment utilizes a master/slave cylinder arrangement in combination with a linkage that controls the position of the ends of the feed roller. The master/slave cylinder arrangement resists the flexing motion associated with offset loading that inconsistent materials generate.

The design uses a master-slave cylinder arrangement.

The feed roller can be maintained in an orientation parallel to the feed table, or, with its axis of rotation perpendicular to the sides, by also using a pivoting linkage to support the feed roller.

The hydraulic circuit is plumbed in a way that the right cylinder is known as the master cylinder, and the left cylinder is the slave cylinder when the feed roller is controlled to provide a crushing force onto the material being processed. The relationship is also reversed at times wherein the left cylinder becomes the master, with the right being the slave, when the feed roller is raised.

The infeed system of this invention includes the mechanism that supports the feed roller. One of the primary benefits of the invention is the ability to reduce the weight and complexity of the feed roller positioning linkage. The preferred embodiment shown utilizes a pivoting frame, with a left pivot and right pivot arm that are connected by a cross-member that primarily serves as a shield or deflector. But other ways to support the feed roller can also be used, one such alternative being disclosed herein.

### BRIEF DESCRIPTION OF THE DRAWINGS

FIG. 1 is a perspective view of a preferred embodiment of a horizontal grinder constructed in accordance with the present invention;

FIG. 2 is an enlarged perspective view of a feed roller suspended above a conveyor belt of the machine of FIG. 1 and showing a pivoting frame that permits the feed roller to move up or down as desired;

FIG. 3 is an enlarged perspective view of a pivoting support frame or yoke to which the feed roller is operatively rotatably attached;

FIG. 4 is an enlarged top view of the conveyor belt and feed roller portion of the machine of FIG. 1;

FIG. 5 is an enlarged side view of the right side of the pivoting yoke/frame with a master cylinder pivotally attached thereto near one end, the master cylinder being operatively pivotally attached to the machine frame on the other end thereof, and showing the distance R1 between the pivotal axis of the yoke and the pivotal axis of the master cylinder to the yoke;

FIG. 6 is an enlarged side view of the left side of the pivoting yoke/frame with a slave cylinder pivotally attached thereto near one end, the slave cylinder being operatively pivotally attached to the machine frame on the other end thereof, and showing the distance R2 between the pivotal axis of the yoke and the pivotal axis of the slave cylinder to the yoke;

FIG. 7 is a schematic view of a control system in the floating mode for the feed roller, the master and slave cylinders;

FIG. 8 is a schematic view of the control system of FIG. 7 in the lift mode for the feed roller, the master and slave cylinders;

FIG. 9 is a schematic view of the control system of FIG. 7 in the crushing down mode for the feed roller, the master and slave cylinders;

FIG. 10 is a schematic view like FIG. 9 in the crushing down mode for the feed roller, but showing a log on the right side between the feed roller and the conveyor belt instead of loose material like that shown in FIG. 9;

FIG. 11 is a schematic view like FIG. 7, but showing an uneven pile of material;

FIG. 12 is an enlarged partial view of a feed roller and suspension system therefore in an alternate embodiment;

FIG. 13 is a schematic view of the control system for the FIG. 11 embodiment using two identical hydraulic cylinders instead of one master cylinder and one slave cylinder as used in the FIGS. 1-10 embodiment;

FIG. 14 is a perspective view of a prior art mounting yoke for a horizontal grinder;

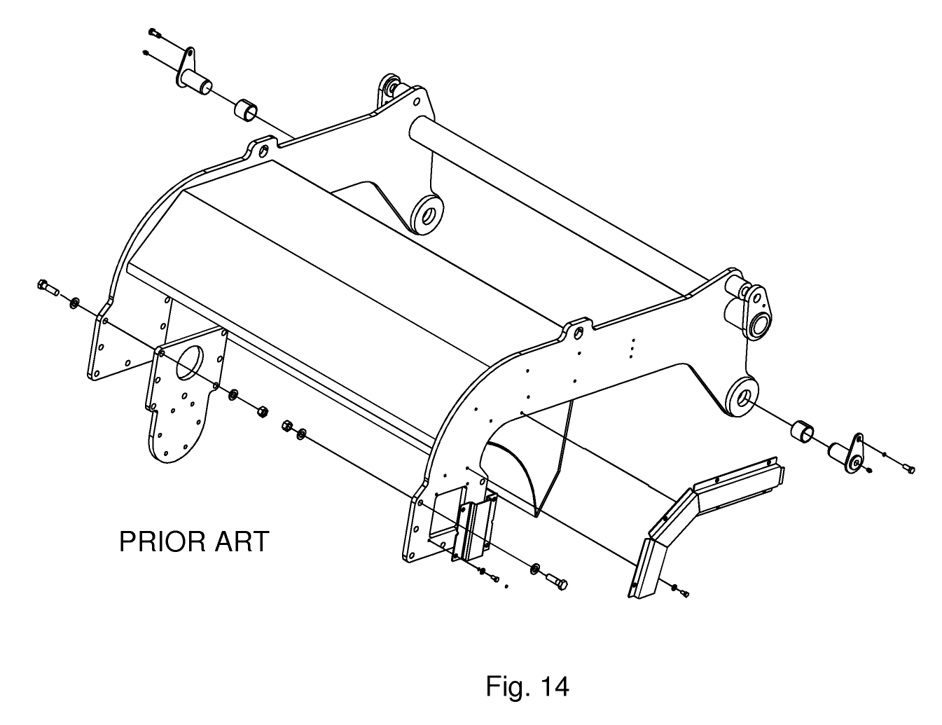

### DETAILED DESCRIPTION OF THE INVENTION

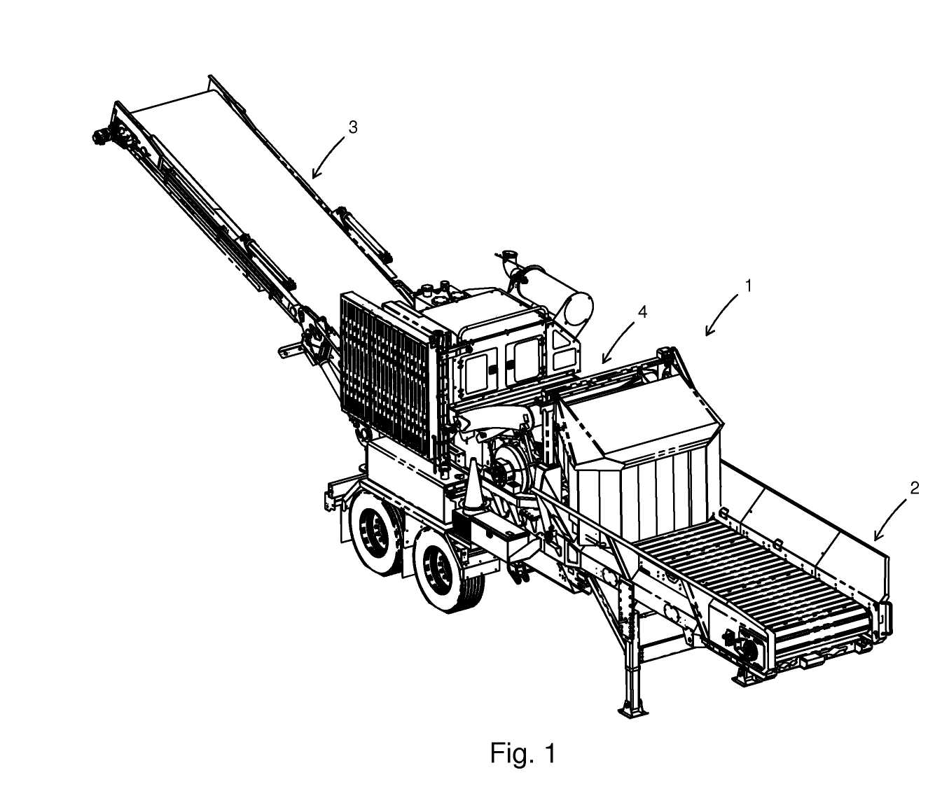

Referring now to the drawings, wherein like reference numerals designate identical or corresponding elements throughout the several views, FIG. 1 shows a horizontal grinder 1 constructed in accordance with the present invention. The horizontal grinder 1 has a feed table 2 for placing material to be ground and an outlet conveyor 3 for transporting the ground-up material into a pile or onto another device (not shown), such as a truck or another conveyor, for transporting the ground-up material to another place.

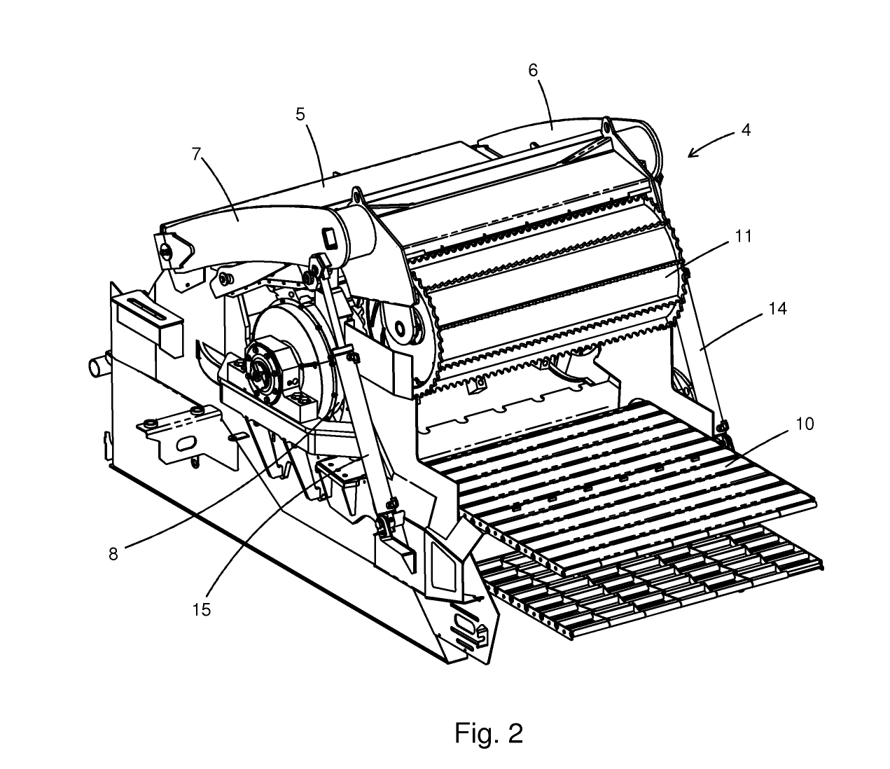

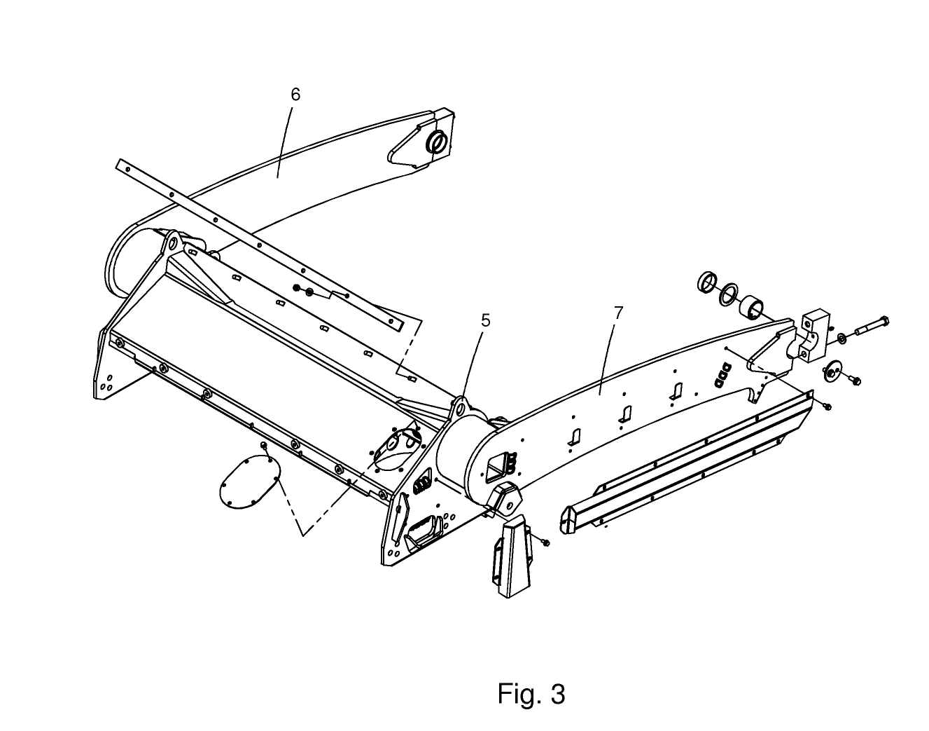

FIG. 1 also shows a feed roller assembly 4 in an intermediate part of the machine 1, the feed roller assembly 4 being also shown by itself in FIG. 2. FIGS. 2 and 3 show the yoke comprising primarily members 5, 6 and 7.

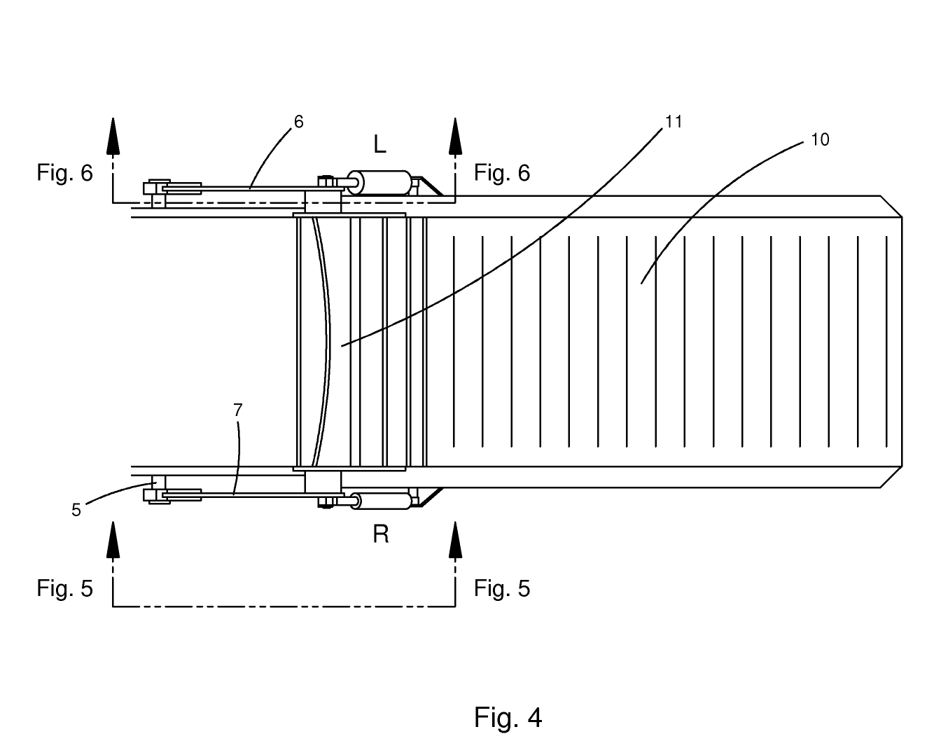

FIG. 4 is a top view that shows the yoke members 5, 6 and 7 mounting the feed roller 11 above the conveyor 10.

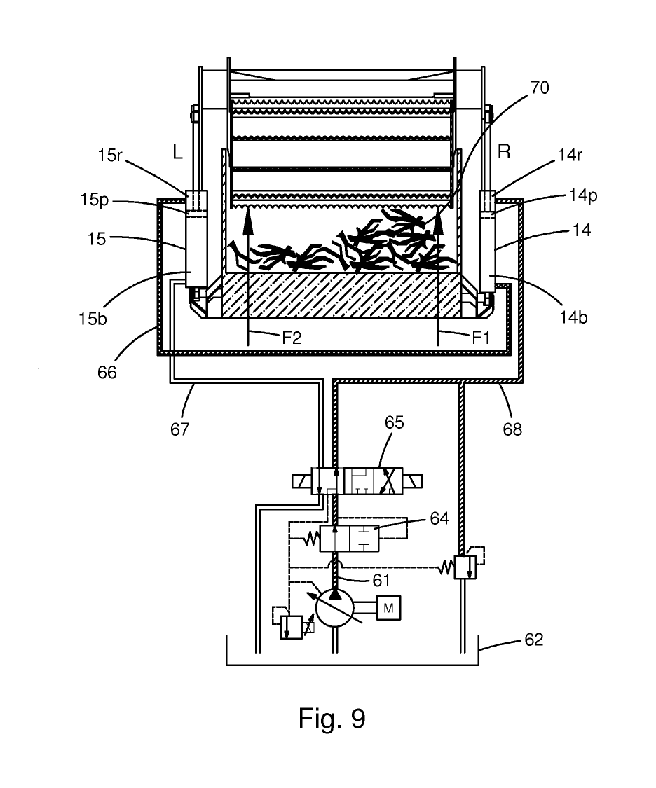

It is to be understood that in general the present invention is an infeed system for a horizontal grinder intended to process loose, unconsolidated materials. The infeed includes a feed table 2 with a chain conveyor 10 on a floor, and sides to support the material to be processed. The infeed system further includes the upper feed roller 11 configured for powered rotation so that the outer surface moves in coordination with the chain conveyor 10 to move material 70, 71 (FIGS. 9-11) to a grinding chamber 8. The feed roller 11 is positioned between the sides to minimize the potential for materials to become wedged or trapped.

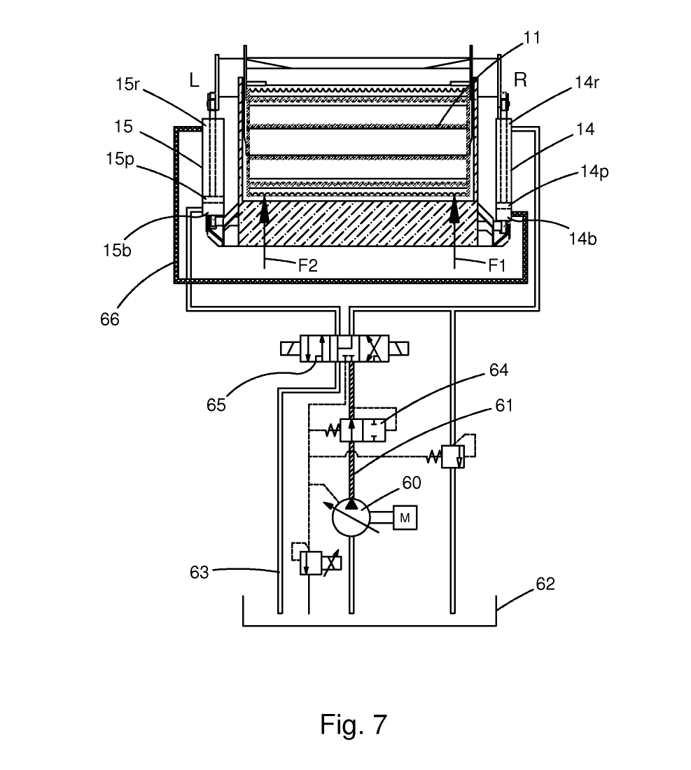

The major advantage of this infeed system is the incorporation of a hydraulic circuit and control system to control the position or orientation of the feed roller to keep it parallel to the feed table. The preferred embodiment utilizes a master/slave cylinder 14/15 arrangement in combination with a linkage that controls the position of the ends of the feed roller. The master/slave cylinder arrangement 14/15 resists the flexing motion associated with offset loading that inconsistent materials generate. The master-slave relationship between the cylinders 14, 15 reverses depending on whether the feed roller 11 is to be forced into the feed material or forced away from the feed material. The design uses a master-slave cylinder arrangement as shown in the schematics shown in FIGS. 7-11. The cylinders used in the preferred embodiment are common cylinders have the following specifications:

1) The left cylinder 14 is a 3.5″ Dia with a 1.5″ rod

2) The right cylinder 15 is a 3.25″ Dia with a 1.5″ rod

With this combination:

1) As the right cylinder is retracted, it displaces 8.3 cubic inches of oil out of butt-end, per inch of movement, while; 2) The left cylinder requires 7.8 cubic inches of oil into the rod-end, per inch of movement.

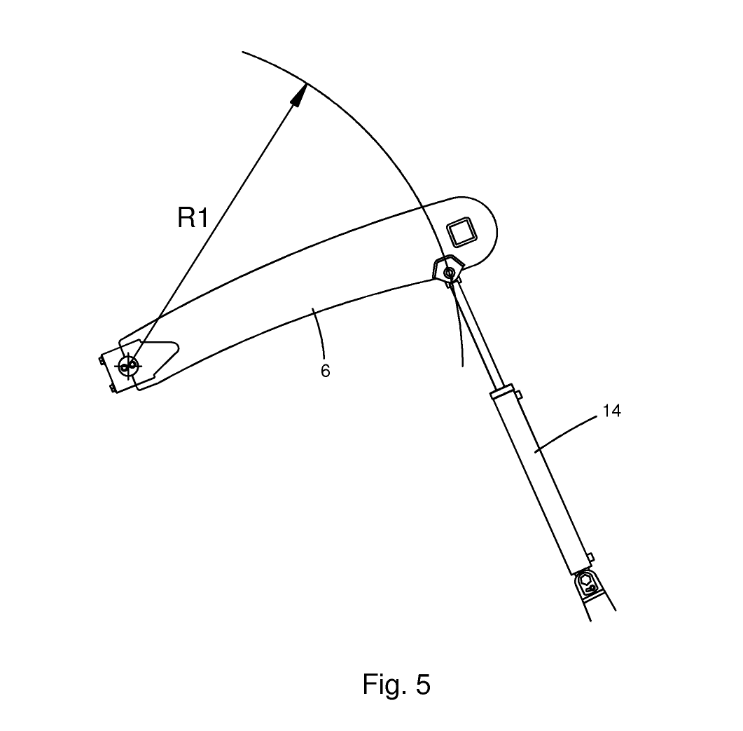

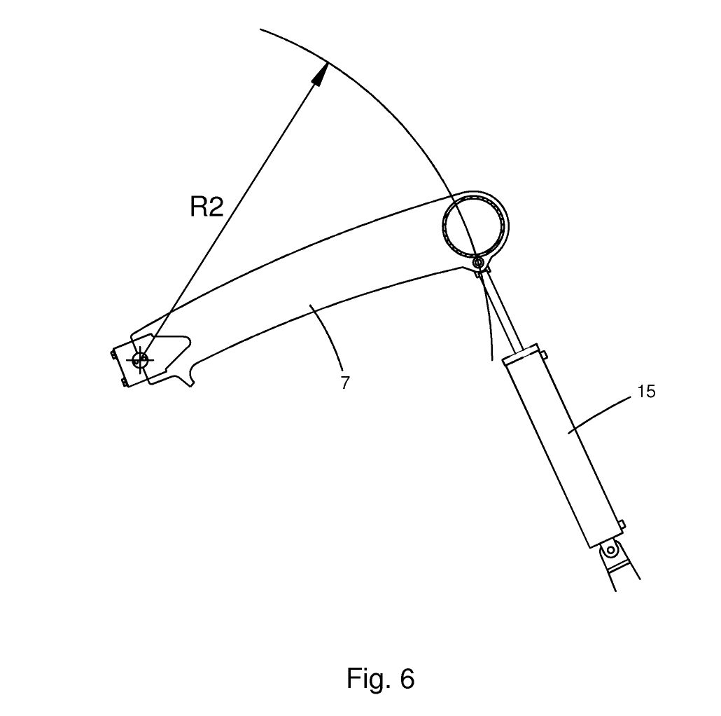

With this combination of cylinders 14/15, the feed roller 11 can be maintained in an orientation parallel to the feed table 2, or with its axis of rotation perpendicular to the sides, by also using a pivoting linkage 5, 6, and 7 to support the feed roller 11, wherein the cylinders 14/15 are connected to this pivoting linkage 5, 6, and 7 on separate radii R1 and R2 as shown in FIGS. 5 and 6, wherein the ratio of these radii R1/R2 is equal to the ratio of the displacements of the cylinders 14/15 noted above. Thus, for the present embodiment, the radius R1 of the left linkage arm (the distance from the axis of rotation of the linkage to the point where the cylinder is attached, is 1.064 times the radius R2 of the right linkage arm.

The hydraulic circuit shown in FIGS. 7-11 is plumbed in a way that the right cylinder 14 is known as the master cylinder, and the left cylinder 15 is the slave cylinder when the feed roller 11 is controlled to provide a crushing force onto the material being processed. When the relationship is reversed, and the left cylinder 15 becomes the master, with the right 14 being the slave, when the feed roller 11 is raised.

The radii R1/R2 could be identical if the correct cylinder size could be implemented, as would be possible if a perfectly matched pair of cylinders was utilized. This slight difference in radius is not detrimental to performance. Since the loading on the feed roller 11 is not balanced, the load on the right cylinder 14 will most often be different that the load on the left cylinder 15. With this master/slave cylinder arrangement in crush mode (FIG. 9) the pressure supplied to the rod-end of the right cylinder 14, by the pump 60, will be different than the pressure supplied to the rod-end of the left cylinder 15, which is supplied by the pressure being expelled from the butt-end 14b of the right cylinder 14. Since the forces applied to the cylinders 14/15 will vary, and since the hydraulic circuit is designed to provide an unbalanced force, there is not a significant advantage associated with the use of a perfectly matched pair of cylinders. Thus standard sizes have been selected, with the benefit of minimizing the cost of the cylinders.

With a master/slave cylinder arrangement 14/15 of this type, the oil contained in the circuit that includes the butt-end 14b of the right cylinder 14, the hose 66 between the cylinders 14/15 and the rod-end 15r of the left cylinder 15 is trapped. This oil does not circulate through the rest of the circuit, and it is a fixed volume of oil. The seals with the cylinders 14/15 will leak to some extent, which is known to affect this volume of oil, which will affect the positioning of the feed roller. This potential problem is alleviated by use of valves (not shown) built into the pistons of the cylinders that allow the pressure to equalize when the feed roller is lowered completely. This valve in the pistons system is well known from other applications of master/slave cylinders so it will not be described in this document.

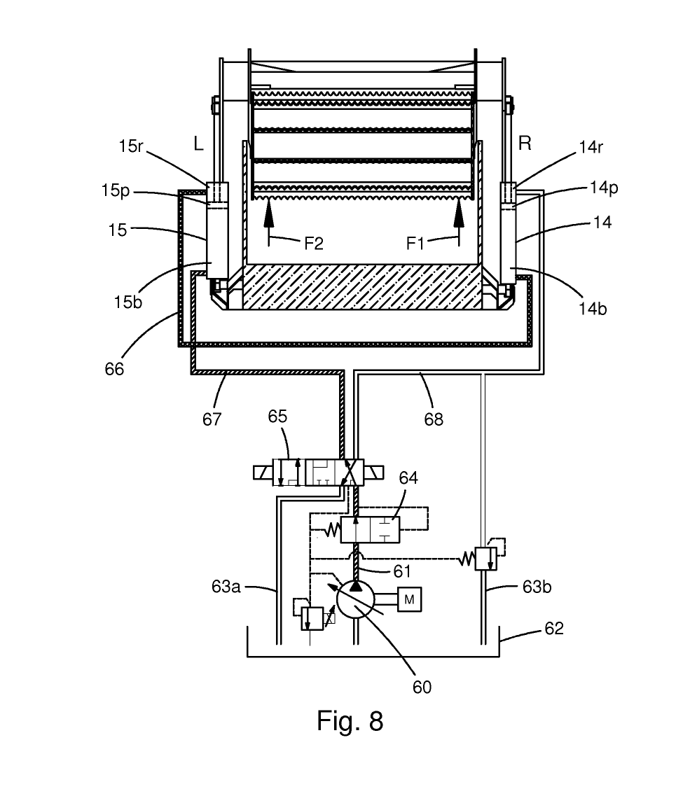

FIG. 7 includes a hydraulic circuit diagram showing the floating mode of an embodiment of a hydraulic control system that can be used in the embodiment of FIGS. 1-10 and that is configured and operates according to aspects of the present invention. In this example, the system includes a hydraulic pump 60 for supply of hydraulic fluid to the system via a hydraulic supply line 61 as well as a hydraulic tank or reservoir 62 which contains the hydraulic fluid to be supplied and which is returned via hydraulic return line 63a/63b (FIG. 8). The operation of the pump 60 and the control of the hydraulic fluid supply may be controlled by a control valve 64.

The hydraulic cylinders 14 and 15 are supplied the hydraulic fluid via supply line 61 and through another control valve 65. In FIG. 7, the supply line 61 is closed because of the position of valve 65. This means that the hydraulic fluid trapped in line 66 communicates with the butt-end 14b of master hydraulic cylinder 14 with the rod side 15r of slave hydraulic cylinder 15. If there is an upward force F1 on the right underneath side of feed roller 11 due to there being more material there on the conveyor belt 10 than force F2 on the underneath left side of roller 11, then the hydraulic fluid will flow from 14b to 15r, i.e. as the right side of the feed roller 11 is held up by force F1, the piston 14p will move up in the cylinder 14, lengthening hydraulic cylinder 14 and causing the right side of the feed roller 11 to move up. As piston 14p moves up, that will also allow fluid to flow from the rod end 15r of cylinder 15 to 14r, causing piston 15p to move up too, thereby lengthening the slave cylinder 15 and causing the right side of the feed roller 11 to move up substantially the same amount that the right side went up.

FIG. 8 shows the control valve 65 moved to the lift mode. In this mode, the two cylinders 14, 15 reverse their master-slave roles compared to FIG. 9. In particular, the left cylinder 15 is now the master cylinder and the right cylinder 14 is now the slave cylinder. Hence, the pressure in line 61 goes into line 67 at the butt-end 15b of the now-master cylinder 15 to cause the cylinder 15 to lengthen. At the same time fluid is allowed to drain from the rod end 14r of the now-slave cylinder 14 to the tank 62 via line 68 and 63a. As the cylinder 15 lengthens, the piston 15p forces the trapped fluid out of rod end 15r, through line 66 and into butt-end 14b of the cylinder 14, causing the cylinder 14 to lengthen as well by substantially the same amount the cylinder 15 lengthens.

FIG. 9 shows the control valve 65 moved to the down/crush mode so that the pressure in line 61 goes into line 68 at the rod end-end 14r of the master cylinder 14 and allowing fluid in line 67 to drain to the tank 62. This causes the master cylinder 14 to shorten, forcing the trapped fluid out of butt end 14b, through line 66 and into rod end 15r of slave cylinder 15, causing slave cylinder 15 to shorten as well by substantially the same amount that master cylinder 14 shortened. This action pushes the feed roller 11 against the material 70 that is on the conveyor belt 10, directly below the feed roller 11. As the feed roller 11 moves down against the material 70, the left side of the feed roller 11 will stay parallel by moving down too to synchronize downward movement with the right side of the feed roller 11 due to fluid in line 66 moving from the butt end 14b of the master cylinder 14 to the rod end 15r of the slave cylinder 15.

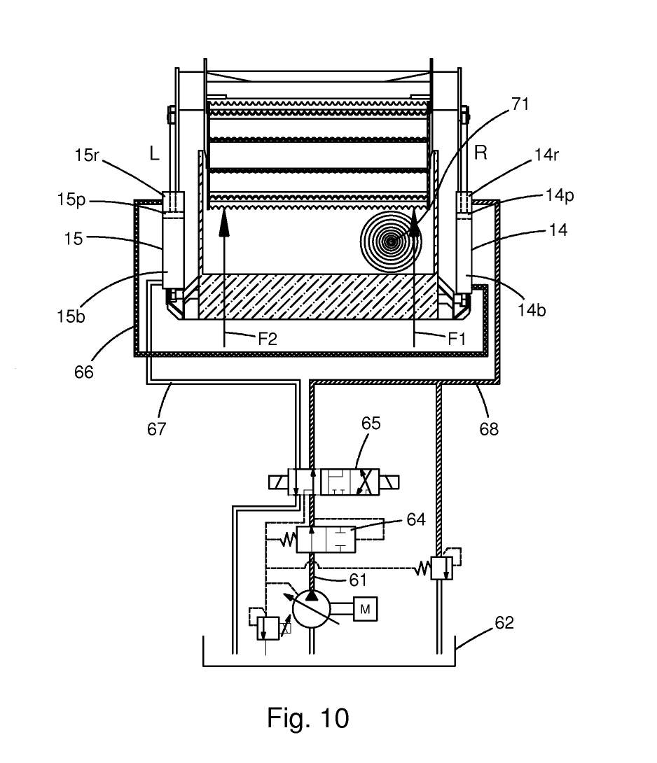

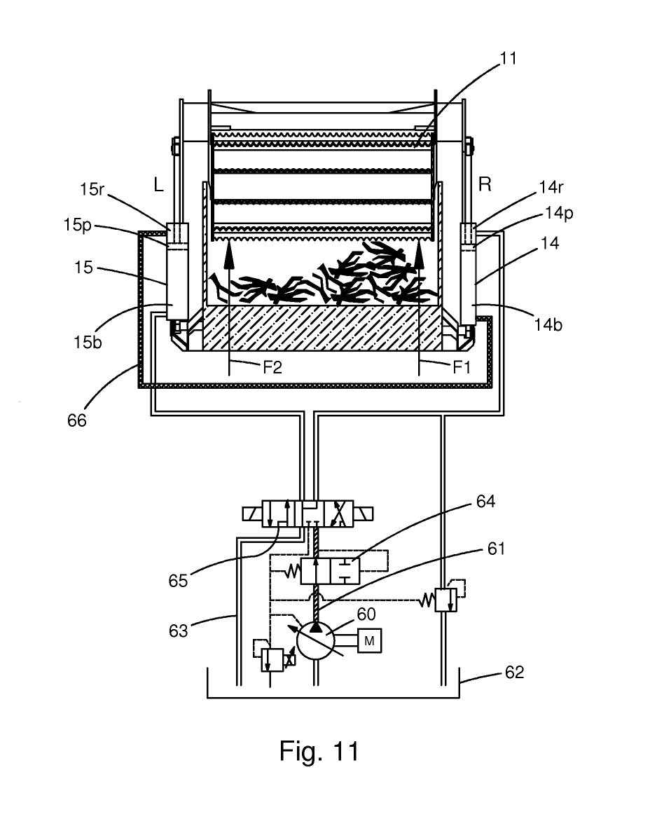

FIG. 10 is essentially the same as that described above with respect to FIG. 9, except that instead of loose material 70, there is a log 71 between the right side of the feed roller 11 and the conveyor belt 10. FIG. 11 is a schematic view like FIG. 7, but showing an uneven pile of material.

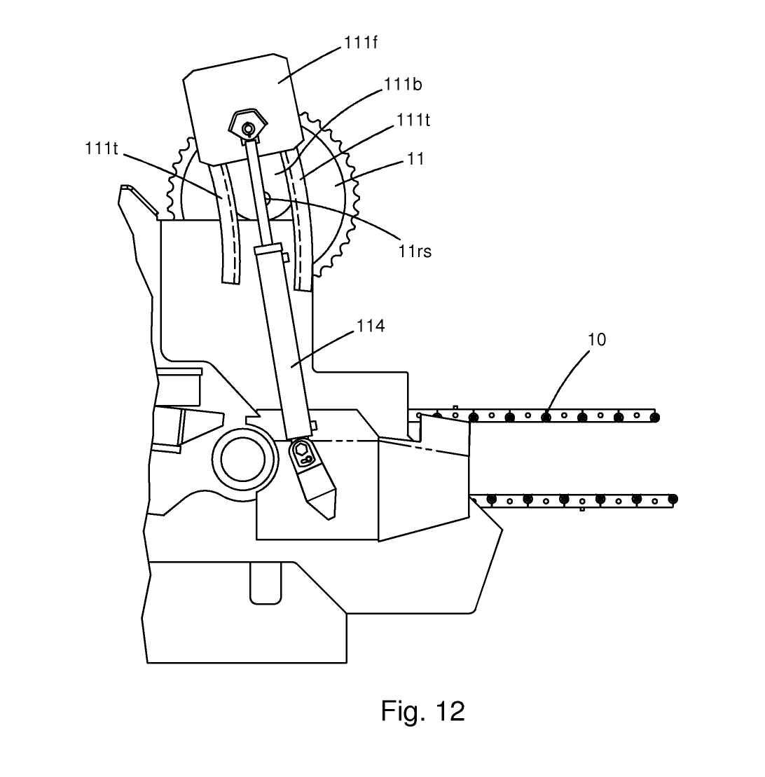

In FIG. 12, instead of using a pivoting frame for the feed roller 11, each side of the feed roller is guided by a follower part 111f on each end of the feed roller 11 to which the feed roller is rotatably attached at rotational shaft 11rs so that the follower part 111f can move up or down in actuate tracks 11t as shown in FIG. 11. Master cylinder 114 is pivotally attached to the follower part 111f at the top and to a part operatively attached to the frame of the machine at the bottom. There would be identical structure on the opposite side of the machine shown in FIG. 11 wherein, if shown, would have all of the parts labeled with the same reference numbers as in FIG. 11, except the hydraulic cylinder on the opposite side would be labeled cylinder 115. In the embodiment of FIG. 12, the hydraulic cylinders 114, 115 will necessarily be of the same dimensions.

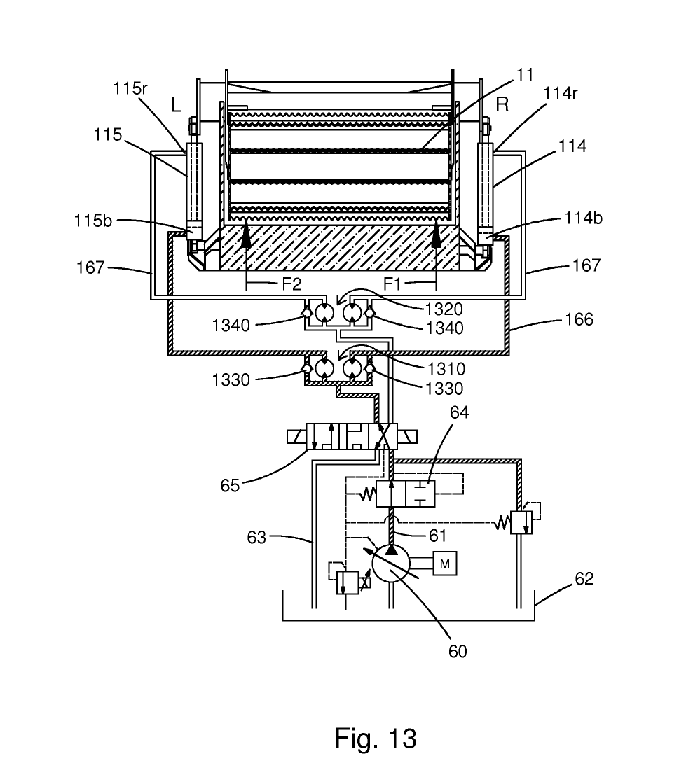

FIG. 13 illustrates an additional embodiment, a schematic control system, of the present invention. This embodiment may be used in conjunction with the pivoting linkage 5, 6, and 7 of FIGS. 1-11 as well as with the follower-actuate tracks assembly of FIG. 12. Fluid flows through the pump 60, through valve 64 in the position shown, and through valve 65 in the position shown which would cause the hydraulic cylinders 114 and 115 to lengthen because equal flow is being directed to through each side of line 166 to each respective cylinder butt end 114b and 115b by a first motor-type flow divider 1310. This equal flow to each respective cylinder butt end 114b and 115b causes synchronous lengthening movement of the cylinders 114 and 115 to thereby keep both sides of the feed roller 11 moving at the same rate regardless of how uneven the material between the feed roller 11 and the conveyor 10 may be. At the same time the hydraulic cylinders 114 and 115 are lengthening, thereby moving the feed roller 11 up, fluid is evacuated from the rod end side 114r and 115r of the cylinders 114 and 115 line 167 via check valves 1340, bypassing the second motor-type flow divider 1320. Of course, if the valve 65 is moved to the position shown in FIGS. 9 and 10, the hydraulic cylinders 114 and 115 will shorten in a synchronized fashion because an equal amount/flow of fluid will flow from the pump 60 to each of the rod end sides 114r and 115r of cylinders 114 and 115 via the second motor-type flow divider 1320, while at the same time an equal amount of fluid will flow from the each respective cylinder butt end sides 114b and 115b of cylinders 114 and 115 to the tank 62 via check valves 1330, bypassing the first motor-type flow divider 1310.

The motor-type flow dividers 1310, 1320 comprise two hydraulic motors, each having a gear on a shared shaft, a single inlet port provides flow to both motors. Each motor has a unique flow outlet. The flow direction may be reversed as can be observed in FIG. 13. Motors may be of gear-on-gear or gerotor design. The flow split may be 50-50 or virtually any other ratio depending on the gear widths chosen.

Obviously many modifications and variations of the present invention are possible in light of the above teachings. It is therefore to be understood that, within the scope of the appended claims, the invention may be practiced otherwise than as specifically described.

1. An infeed system for a horizontal grinder comprising an infeed frame, an infeed table with a conveyor that defines a material support plane and that has a front end positioned adjacent a grinding chamber, and an opposing rear end, and left and right sides; a left vertical side wall and a right vertical side wall; and an upper feed roller configured to fit between the side walls in a way to minimize the amount of material that can fit between the feed roller and the side walls, the infeed system comprising:
a feed roller support that positions the feed roller allowing it to move through a range of motion having a left linkage on the left side and a right linkage on the right side, wherein the feed roller support is a pivoting linkage pivoted about a pivot axis, the pivoting linkage including a left pivot arm with a left pivot arm proximal end adjacent the pivot axis and a left pivot arm distal end, and a right pivot arm with a right arm proximal end adjacent the pivot axis and a right arm distal end;
a left cylinder operatively connected on one end to the left linkage and on the opposite end to the infeed frame;
a right cylinder operatively connected to the right linkage on one end and to the infeed frame on the opposite end, the right cylinder having a different displacement size than the left cylinder; and
a hydraulic circuit and control system that automatically synchronizes the movement of the left cylinder with the movement of the right cylinder to keep the feed roller parallel to the material support plane, wherein the hydraulic circuit and control system comprises:
a hydraulic circuit wherein the cylinders are arranged in a master-slave relationship; and
wherein the feed roller support linkages and the cylinders are arranged to keep the feed roller parallel to the material support plane.

2-3. (canceled)

4. The An infeed system for a horizontal grinder comprising an infeed frame, an infeed table with a conveyor that defines a material support plane and that has a front end positioned adjacent a grinding chamber, and an opposing rear end, and left and right sides; a left vertical side wall and a right vertical side wall; and an upper feed roller configured to fit between the side walls in a way to minimize the amount of material that can fit between the feed roller and the side walls, the infeed system comprising:
a feed roller support that positions the feed roller allowing it to move through a range of motion having a left linkage on the left side and a right linkage on the right side;
a left cylinder operatively connected on one end to the left linkage and on the opposite end to the infeed frame;
a right cylinder operatively connected to the right linkage on one end and to the infeed frame on the opposite end;
a hydraulic circuit and control system that automatically synchronizes the movement of the left cylinder with the movement of the right cylinder to keep the feed roller parallel to the material support plane; and
wherein one end of a first cylinder is connected to a first pivot arm at a first effective radius and the first cylinder is sized such that oil that is displaced from one end of the first cylinder, upon rotation of the first pivot arm through a first angle, is directed to the other end of a second cylinder wherein one end of the second cylinder is connected to the second pivot arm at a second effective radius and the resulting displacement of the second cylinder results in rotation of the second pivot arm that is equal to the first angle.

5. The infeed system of claim 1 wherein the pivoting linkage further comprises one cross-member connecting the distal end of the left linkage and distal end of the right linkage.

6. The infeed system of claim 1 wherein the hydraulic circuit and control system comprises:
a first motor-type flow divider that receives an inlet flow from a pressurized fluid source, divides the flow at a predetermined flow ratio, passes a first outlet flow to the left cylinder, and passes a second outlet flow to the right cylinder; and
a second motor-type flow divider that receives a second inlet flow from the left cylinder, and a third inlet flow from the right cylinder, said second and third inlet flows being at the predetermined flow ratio, and passes the outlet flow to a tank.

7. A method of operating an infeed system for a horizontal grinder comprising an infeed frame, an infeed table with a conveyor that defines a material support plane and that has a front end positioned adjacent a grinding chamber, and an opposing rear end, and left and right sides; a left vertical side wall and a right vertical side wall; and an upper feed roller configured to fit between the side walls in a way to minimize the amount of material that can fit between the feed roller and the side walls, the infeed system comprising:
a feed roller support that positions the feed roller allowing it to move through a range of motion having a left linkage on the left side and a right linkage on the right side; a left cylinder operatively connected on one end to the left linkage and on the opposite end to the infeed frame; and a right cylinder operatively connected to the right linkage on one end and to the infeed frame on the opposite end;
said method comprising:
synchronizing the movement of the left cylinder with the movement of the right cylinder to keep the feed roller parallel to the material support plane.

8. The method of claim 7 wherein the synchronizing further comprises:
using a hydraulic circuit to connect the cylinders in a master-slave relationship in order to keep the feed roller parallel to the material support plane.

9. The method of claim 7 comprising using a pivoting linkage including a left pivot arm with a proximal end adjacent the pivot axis and a distal end and a right pivot arm with a proximal end adjacent the pivot axis and a distal end to attached the feed roller support to the infeed frame.

10. The method of claim 9 comprising attaching one end of a first cylinder to a first pivot arm at a first effective radius and sizing the first cylinder such that the oil that is displaced from the one end of the first cylinder, upon rotation of the pivot arm through a first angle, is directed to the other end of a second cylinder so that one end of the second cylinder is connected to the second pivot arm at a second effective radius and the resulting displacement of the second cylinder results in rotation of the second pivot arm that is equal to the first angle.

11. The method of claim 9 comprising using one cross-member connecting the distal end of the left linkage and distal end of the right linkage to form the pivoting linkage.

12. The method of claim 7 wherein synchronizing the movement of the left cylinder with the movement of the right cylinder comprises:
receiving a flow from a pressurized fluid source;
dividing the flow received from the pressurized fluid source in a predetermined ratio of flows in a flow divider;
passing a first fraction of the flow received from the pressurized fluid source to the left cylinder; and
passing a second fraction of the flow received from the pressurized fluid source to the right cylinder.

13. The method of claim 12 additionally comprising:
receiving a first inlet flow from the left cylinder into a first inlet port;
receiving a second inlet flow from the right cylinder into a second inlet port;
combining the first and second inlet flows; and
passing the combined first and second inlet flows out an outlet port.

14. The infeed system of claim 4 further comprises a cross-member connecting the left linkage and the right linkage.

15. The infeed system of claim 4 wherein the second effective radius is different than the first effective radius.

16. The infeed system of claim 4 wherein the right cylinder has a displacement size different than a displacement size of the left cylinder.

17. A hydraulic control system for a first hydraulic cylinder and a second hydraulic cylinder arranged in a master-slave relationship, said hydraulic control system comprising:
a hydraulic pump for supply of hydraulic fluid to the system via a hydraulic supply line;
a hydraulic reservoir containing hydraulic fluid for the hydraulic pump and which hydraulic fluid is returned from one hydraulic cylinder via a hydraulic return line to the reservoir when hydraulic fluid is being supplied to the other hydraulic cylinder;
the first hydraulic cylinder having a first end and a second end and a first internal displacement size with a first piston disposed therein, a first piston rod operatively attached to the first piston, the first piston rod being disposed in a first end of the first hydraulic cylinder, a first port in the first end of the first hydraulic cylinder and a second port in the second end of the first hydraulic cylinder;
the second hydraulic cylinder having a first end and a second end and a second internal displacement size with a second piston disposed therein, a second piston rod operatively attached to the second piston and being disposed in a first end of the second hydraulic cylinder, a first port in the first end of the second hydraulic cylinder and a second port in the second end of the second hydraulic cylinder;
a pressurized fluid supply line operatively selectively attached between the reservoir and the second port in the second end of the second hydraulic cylinder and a fluid return line selectively operatively fluidly connecting the first port in the first end of the first hydraulic cylinder to the reservoir when the a pressurized fluid supply line is supplying fluid to the second port in the second end of the second hydraulic cylinder;
the pressurized fluid supply line being operatively selectively attached between the reservoir and the first end of the first hydraulic cylinder and a fluid return line selectively operatively fluidly connecting the second port in the second end of the second hydraulic cylinder to the reservoir when the a pressurized fluid supply line is supplying fluid to the first port in the first end of the first hydraulic cylinder; and
wherein the second internal displacement size of the second hydraulic cylinder is larger than the first internal displacement size of the first hydraulic cylinder.
